(19) United States
(12) Patent Application Publication
(10) Pub. No.: US 2006/0064321 A1
(43) Pub. Date: Mar. 23, 2006

(54) Medical image management system

(75) Inventors: Yasuhiko Sasano, Tokyo (JP); Shuuhei Mori, Tokyo (JP); Hiroyuki Kubota, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Medical & Graphic, Inc.

(21) Appl. No.: 11/208,665

(22) Filed: Aug. 22, 2005

(30) Foreign Application Priority Data
Aug. 25, 2004 (JP) 2004-245369
Aug. 25, 2004 (JP) 2004-245394

(51) Int. Cl. G06Q 10/00

(52) U.S. Cl. 705/2; 382/128

(57) ABSTRACT

A medical image management system includes: a storage storing a medical image; a radiogram interpretation terminal reading and displaying the medical image from the storage according to instruction inputted by a radiogram interpretation doctor; a schedule storage unit for storing schedule information setting a date and time when each radiogram interpretation doctor takes charge of a radiogram interpretation; a login storage unit for storing login information to every radiogram interpretation doctor, the login information indicating whether the doctor has logged in to the terminal; and a control unit, when a medical image of a radiogram interpretation object is stored in the storage, for discriminating a doctor set as a radiogram interpretation doctor in charge at a specified date and time and having logged in to the terminal based on the schedule and login information and for determining the doctor as a radiogram interpretation doctor in charge of the medical image.

### BACKGROUND OF THE INVENTION

1. Field of the Invention

The present invention relates to a medical image management system which manages a medical image acquired by examination radiographing and controls the input and the output of the medical image.

2. Description of the Related Art

In a medical institution such as a hospital, the management of the medical images acquired by examination radiographing is systematized. For example, the data of medical images radiographed and generated by various radiographing apparatuses (hereinafter each referred to as a modality) such as an X-ray radiographing apparatus, a computed tomography (CT) apparatus, a magnetic resonance imaging (MRI) apparatus, and an ultrasonic photographing apparatus is transmitted to a server through a communication network installed in a hospital, and the transmitted data is made to be a database by the server to be saved and managed. Also a system enabling an examination reservation so as to meet the schedule of an examination engineer at the time of the examination reservation has been developed (see, for example, JP-Tokukai-Hei-5-197768A).

If medical images are saved, each radiogram interpretation doctor (a doctor who performs a radiogram interpretation) is assigned medical images the radiogram interpretations of which the doctor takes charge of by a server. A radiogram interpretation doctor can read and observe only the medical images which are assigned to the doctor from the database through a terminal for radiogram interpretation (hereinafter referred to a radiogram interpretation terminal) installed in each consultation room. Conventionally, a radiogram interpretation doctor in charge of a radiographed medical image is conventionally specified at the time of an examination reservation, and a server determines a radiogram interpretation doctor in charge to whom a medical image is assigned based on the specification information of the radiogram interpretation doctor in charge when the data of the medical image has been generated in a modality and the data has been inputted into the server.

However, if the radiogram interpretation doctor in charge is fixed in such a way, because medical images are one-sidedly assigned also on a day when the radiogram interpretation doctor in charge is not in his or her office on his or her holiday, the medical images are assigned to the absent radiogram interpretation doctor in charge one after another although the schedules of other radiogram interpretation doctors are vacant. As a result, the radiogram interpretations of the medical images are delayed for an absent period, and the efficiency of radiogram interpretation operations lowers as a whole.

Moreover, even when a radiogram interpretation doctor is at his or her office, the doctor is not always using a radiogram interpretation terminal. For example, because medical imagers are one-sidedly assigned even when the doctor is not at the radiogram interpretation terminal owing to a meeting or the like although the doctor is at his or her office, the radiogram interpretations of the medical images are delayed likewise.

Accordingly, it is necessary to assign medical images being objects of radiogram interpretations according to the schedule of a radiogram interpretation doctor. A technique described in JP-Tokukai-Hei-5-197768A is a technique enabling an examination reservation to meet a schedule of an examination engineer, namely the technique pertains to the reservation of an examination apparatus. Consequently, the technique cannot cope with the assignment of the radiogram interpretation doctors in charge of medical images.

On the other hand, in recent years, a style which displays a medical image on a display unit such as a liquid crystal display (LCD) instead of a film to perform radiogram interpretation has been increasing. Medical images include various kinds of images such as an X-ray image, a tomographic image radiographed by a computed tomography (CT) apparatus (hereinafter referred to as a CT image) and an MRI image radiographed by a magnetic resonance imaging (MRI) apparatus. Owing to the digitization of medical images, it becomes possible to display images in various display formats by splitting one screen into several regions such as a format of displaying an X-ray image and a CT image simultaneously, and a format of displaying an X-ray image radiographed in the past and a present X-ray image of the same patient simultaneously.

Because the optimum display format differs according to the inclination of a radiogram interpretation doctor and a site of a diagnosis object, conventionally the radiogram interpretation doctor changes the setting of a display device for performing a radiogram interpretation to an inclined display format to display medical images. Consequently, when the display device with which the radiogram interpretations are performed is changed, the inclined display format is needed to be set again. For omitting such troublesome operations, a method of making a medical image be displayed under the same conditions even between different display devices has been disclosed (see, for example, JP-Tokukai-2002-143095A).

However, although the technique described in the above-mentioned JP-Tokukai-2002-143095A can customize display conditions, it is only the first screen that can be customized, and the display conditions after that must be operated likewise each time by the radiogram interpretation doctor. When the number of images such as a past image, a present image, a CR image and a CT image has increased at the time of radiogram interpretations, many screen transitions have been passed through in many cases. In particular, because the numbers of the images of CT images and MRI images are very large as compared with CR images, the frame advancing operations of the CT images and the MRI images should be performed every image at the radiogram interpretations of them, and such display operations are still troublesome.

Consequently, it is required to automatize the display operation at the time of a radiogram interpretation, and to attain the improvement of the efficiency of a radiogram interpretation operation.

### SUMMARY OF THE INVENTION

It is an object of the present invention to provide a medical image management system enabling the real-time determination of a radiogram interpretation doctor in charge of a medical image according to the schedules of radiogram interpretation doctors.

In order to attain the above-mentioned object, according to a first aspect of the present invention, a medical image management system includes:
an image storage device storing a medical image acquired by radiographing;
a radiogram interpretation terminal reading and displaying the medical image from the image storage device according to an instruction inputted by a radiogram interpretation doctor;
a schedule storage unit for storing schedule information setting a date and time when each radiogram interpretation doctor takes charge of a radiogram interpretation;
a login storage unit for storing login information to every radiogram interpretation doctor, the login information indicating whether the radiogram interpretation doctor has logged in to the radiogram interpretation terminal or not; and
a control unit, when a medical image of a radiogram interpretation object is stored in the image storage device, for discriminating a radiogram interpretation doctor who is set as a radiogram interpretation doctor in charge at a specified date and time and having logged in to the radiogram interpretation terminal based on the schedule information and the login information and for determining the radiogram interpretation doctor as a radiogram interpretation doctor in charge of the medical image stored in the image storage device.

According to the medical image management apparatus of the present invention, because the medical image management apparatus determines a radiogram interpretation doctor who can be in charge of a radiogram interpretation at a specified date and time and who has logged in to a radiogram interpretation terminal as a radiogram interpretation doctor in charge of a medical image, it is possible to assign a medical image of a radiogram interpretation object to a radiogram interpretation doctor in charge of the medical image in real time so as to meet the schedule of each radiogram interpretation doctor. Thereby, the assignment of a charge of a medical image to an absentee can be prevented, and the delay of a radiogram interpretation can be avoided.

Moreover, it is preferable that the schedule storage unit stores information of a kind of a medical image the radiogram interpretation of which each radiogram interpretation doctor takes charge of as well as the schedule information of each radiogram interpretation doctor, and
the control unit discriminates the kind of the medical image based on information pertaining to an image incidental to the medical image of the radiogram interpretation object to determine a radiogram interpretation doctor as the radiogram interpretation doctor in charge of the medical image based on the stored schedule information and the information of the kind of the medical image the radiogram interpretation of which each radiogram interpretation doctor takes charge of, the determined radiogram interpretation doctor set as a doctor in charge of the radiogram interpretation at a specified date and time based on the schedule information and having logged in to the radiogram interpretation terminal among radiogram interpretation doctors corresponding to the discriminated kind.

According to the present invention, because the radiogram interpretation doctor according to the kind of the medical image is determined as the radiogram interpretation doctor in charge, the medical image of the kind which each radiogram interpretation doctor can take charge of can be pertinently assigned to each radiogram interpretation doctor.

Moreover, it is preferable that, when a plurality of radiogram interpretation doctors is set to a medical image of the same kind, the schedule storage unit stores a priority order of radiogram interpretations set to the plurality of radiogram interpretation doctors, and
the control unit discriminates the radiogram interpretation doctors having logged in to the radiogram interpretation terminal in order of the height of the stored priority order to determine the discriminated radiogram interpretation doctor as the radiogram interpretation doctor in charge.

According to the present invention, because a radiogram interpretation doctor in charge is determined sequentially in the order of the height of the priority order, even when the radiogram interpretation doctor is absent and has not logged in, it is possible to assign the medical image of the radiogram interpretation object to another radiogram interpretation doctor capable of taking the charge of the medical image, and the delay of the radiogram interpretation can be prevented.

### BRIEF DESCRIPTION OF THE DRAWINGS

The present invention will be more completely understood with the detailed descriptions shown below and the attached drawings. However, these do not intend to limit the present invention, wherein:

FIG. 1 is the diagram showing the system configuration of a medical image management system according to the present embodiment;

FIG. 2 is a diagram showing the internal configuration of a server;

FIG. 3 is a view showing an example of the data configuration of a schedule table;

FIG. 4 is a view showing an example of the data configuration of a login table;

FIG. 5 is a flowchart describing image control processing executed by a server;

FIG. 6 is a diagram showing the internal configuration of a radiogram interpretation terminal;

FIG. 7 is a view showing an example of the data configuration of a trace pattern table or a standard pattern table;

FIG. 8 is a flowchart for illustrating the learning mode processing executed by the radiogram interpretation terminal;

FIG. 9 is a flowchart for illustrating the trace processing executed at the time of learning mode processing;

FIG. 10 is a view showing an example of a transition of a display screen at the time of an automatic mode; and

FIG. 11 is a flowchart for illustrating the automatic mode processing executed by the radiogram interpretation terminal.

### DETAILED DESCRIPTION OF THE PREFERRED EMBODIMENTS

Hereinafter, an embodiment according to a medical image management system of the present invention is described with reference to the attached drawings.

### First Embodiment

In the present embodiment, a following example is described. In the example, a server managing input and output of medical images stored in an image storage device stores schedule information setting the days for radiogram interpretations of each radiogram interpretation doctor therein, and detects the login situation of each radiogram interpretation doctor in a radiogram interpretation terminal to store the detected login situation as login information. When a medical image is generated in a modality and is stored in an image storage device, a radiogram interpretation doctor corresponding to a day in charge of a radiogram interpretation and having logged in to a radiogram interpretation terminal is discriminated based on schedule information and login information, and the radiogram interpretation doctor is determined as the radiogram interpretation doctor in charge of the medical image.

First, the configuration is described.

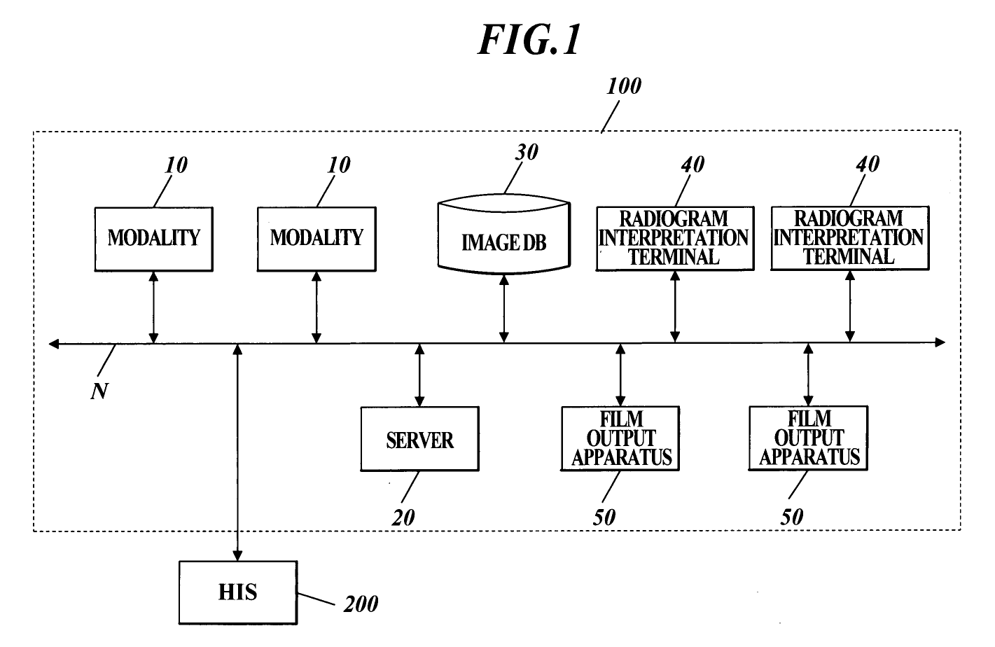

FIG. 1 shows the system configuration of a medical image management system 100 in the present embodiment.

As shown in FIG. 1, the medical image management system 100 comprises modalities 10, a server 20, an image data base (DB) 30, radiogram interpretation terminals 40 and film output apparatuses 50. Each apparatus is connected to one another through a communication network N, which is built in pursuance of Digital Imaging and Communication in Medicine (DICOM) standards, in a state capable of mutual transmission and reception of data. Incidentally, the installation number of each apparatus shown in FIG. 1 is an example, and the installation number is not especially limited.

The medical image management system 100 is connected to a hospital information system (HIS) 200 through the communication network.

The HIS 200 is an information management system managing the information in a hospital. The HIS 200 generates radiographing order information including patient information pertaining to a patient of a radiographing object such as a patient ID, a name and a sex of the patient, examination information pertaining to an examination such as an examination ID of the examination, a radiographing site specified by the examination and a radiographing method, and the like when the HIS 200 has received a request from a doctor, and the HIS 200 manages the generated radiographing order information by attaching identification information of the radiographing order information (hereinafter referred to order ID). The HIS 200 transmits the generated radiographing order information to each modality 10 of the medical image management system 100.

Incidentally, although the example in which the HIS is applied as the originator of the radiographing order information is described in the present embodiment, the HIS can be applied also to the receptionist terminal which performs issue reception of the radiographing order information, a radiology information system (RIS) managing the information in a department of radiology and the like Hereinafter, each component of the medical image management system 100 is described.

The modalities 10 are ones generating medical image data by digitizing a medical image produced by radiographing a patient. For example, modalities radiographing medical images of various image kinds such as the images of an MRI apparatus and an ultrasonic photographing apparatus as well as the images of a CR apparatus, a CT apparatus, a reading apparatus reading an X-ray image recording on an X-ray film can be applied.

The modalities 10 radiograph a patient in pursuance of radiographing order information generated by the HIS 200 to generate the data of the medical image. Then, the modalities 10 give the patient information and examination information for specifying a medical image to the generated data of the medical image as the information pertaining to the image, and give the series information pertaining to the radiographing such as the names of the modalities 10, the operator name and examination site, and image related information such as the generation day and time of the medical image and bit information to the medical image as the information pertaining to the image too to transmit the information to the server 20.

A server 20 saves the data of the medical image transmitted from the modalities 10 in an image DB 30 as an original image to manage the data. Moreover, the server 20 manages the login situation of each radiogram interpretation doctor in the radiogram interpretation terminals 40, and limits the input and the output of each medical image saved in the image DB 30 according to the radiogram interpretation doctor who has logged in.

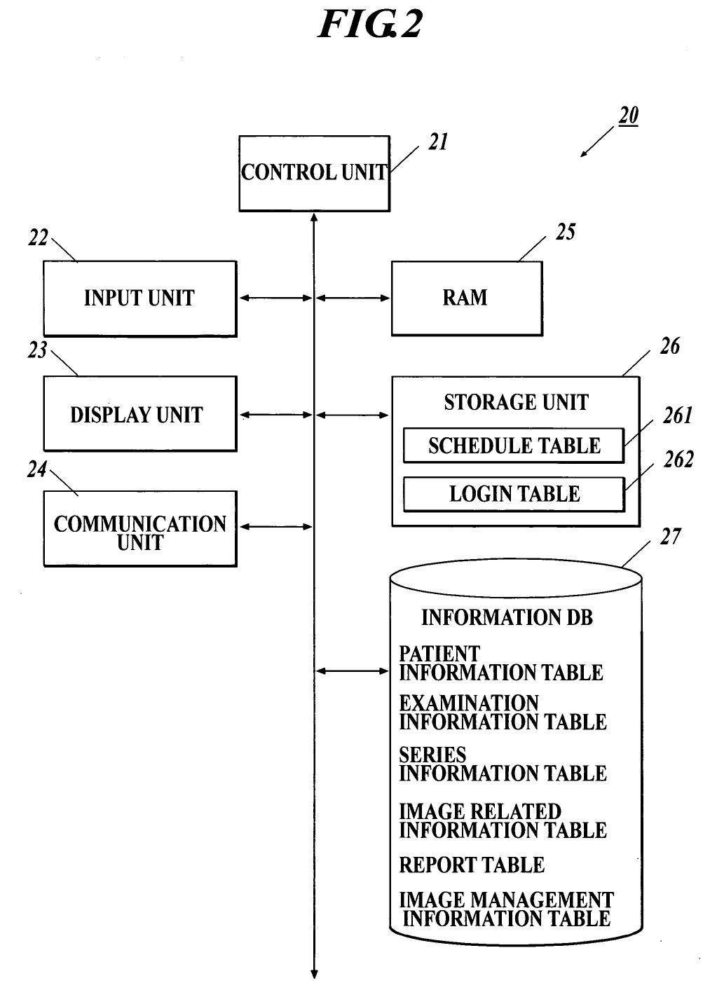

The internal configuration of the server 20 is shown in FIG. 2.

As shown in FIG. 2, the server 20 comprises a control unit 21, an input unit 22, a display unit 23, a communication unit 24, a random access memory (RAM) 25, a storage unit 26 and an information DB 27.

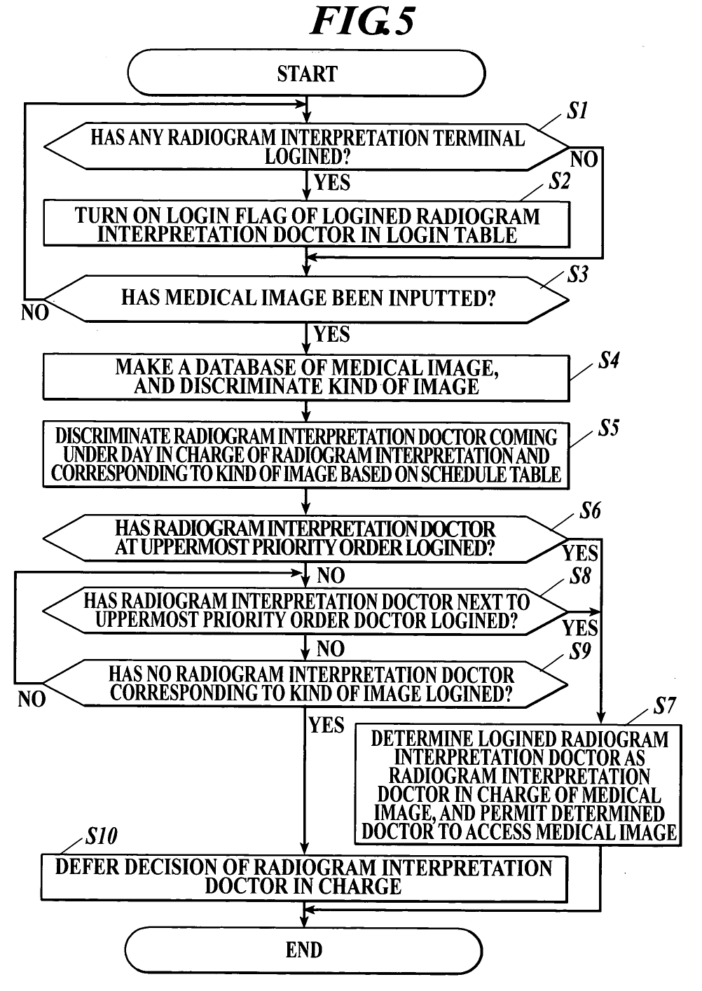

The control unit 21 comprises a central processing unit (CPU) and the like. The control unit 21 expands the image control processing program (see FIG. 5) and the like according to the present invention as well as the system program stored in the storage unit 26 in the RAM 25, and wholly controls the processing operation by the cooperation with the program.

The control unit 21 makes the image DB 30 save the medical images generated by the modalities 10 as the original images, and generates various images such as DICOM compression images (images compressed in pursuance of DICOM standards) and thumbnail images for an index based on an original image to make the image DB 30 save the various images as the necessary images at the time of a radiogram interpretation. Moreover, the control unit 21 compiles the patient information and the examination information which have been acquired from HIS 200 previously as a DB, and makes the information DB 27 store the compiled DB in a rewritable way. Furthermore, the control unit 21 compiles the series information and the image related information included in the incidental information of a newly inputted medical image as a DB as the information pertaining to the image, and makes the information DB store the compiled DB.

Moreover, the control unit 21 makes the information DB 27 store the patient information, the examination information, the series information and the image related information based on the incidental information of the medical image. Furthermore, the control unit 21 compiles the report information pertaining to the diagnoses produced by each radiogram interpretation terminal 40 as a DB, and makes the information DB 27 store the compiled DB.

Moreover, in the image control processing, when a radiogram interpretation doctor logs in to any radiogram interpretation terminals 40, the control unit 21 sets a flag indicating the login of the radiogram interpretation doctor in a login table 262 in the storage unit 26. When the logoff of the radiogram interpretation doctor is performed, the control unit 21 sets a flag indicating the logoff. Then, when a medical image of a new radiogram interpretation object is inputted from a modality 10, the control unit 21 discriminates the kind of the image based on the incidental information incidental to the medical image, and discriminates a radiogram interpretation doctor who corresponds to the discriminated image kind and is set to the day in charge of a radiogram interpretation at the present date and time based on a schedule table 261, and is set as the day for radiogram interpretation in the present time will be distinguished. Furthermore, the control unit 21 discriminates whether any radiogram interpretation doctors has logged in or not in the order of the height of the priority order set in the schedule table 261 based on the login table 262. Then, the control unit 21 determines the radiogram interpretation doctor who has logged in as a radiogram interpretation doctor in charge of the radiogram interpretation of the new medical image, and the control unit 21 permits the access to the medical image. That is, by the cooperation of the image control processing program and the control unit 21, a control unit can be realized.

The input unit 22 comprises a keyboard including numeric keys, character keys, function keys, and the like, and a mouse, and the like. The input unit 22 outputs an operation signal corresponding to a key which has been manipulated to the control unit 21.

The display unit 23 is a display unit comprising a liquid crystal display (LCD) and the like, and displays various screen data such as processing results by means of various operation screens and the control unit 21.

The communication unit 24 comprises an interface for communication of a network interface card (hereinafter referred to as an NIC), a modem, and the like, and mutually transmits and receives information to and from an external device on the communication network N. For example, the communication unit 24 receives a medical image and its incidental information from a modality 10. Moreover, the communication unit 24 transmits a medical image being a saving object and report information produced by a radiogram interpretation terminal 40 to the image DB 30.

The RAM 25 forms a work area storing various programs executed by the control unit 21 and the data related to the various programs temporarily.

The storage unit 26 stores an image control processing program, the data processed by each program, and the like as well as a system program.

Moreover, the storage unit 26 is a schedule storage unit and login storage unit for storing the schedule table 261 and the login table 262, which are used for image control processing.

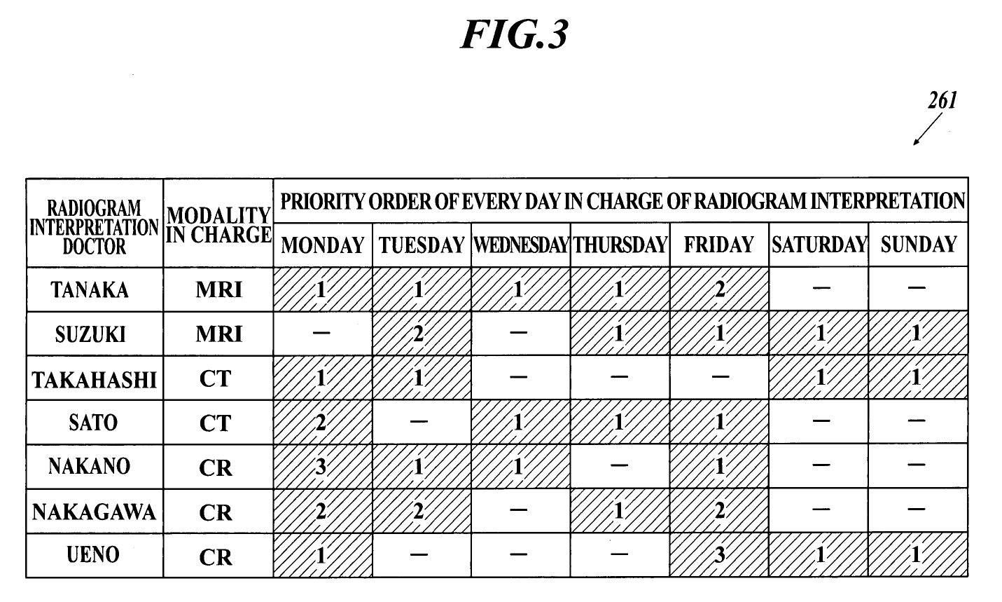

The schedule table 261 sets schedules showing the dates and the times at which each radiogram interpretation doctor, who is previously registered, takes charge of a radiogram interpretation. As shown in FIG. 3, in the schedule table 261, a radiogram interpretation doctor name (for example, “Tanaka”), a modality (for example, “MRI”) which the radiogram interpretation doctor takes charge, and a schedule (a schedule for every day of the week from “Monday” to “Friday”) of the radiogram interpretation doctor are set to each radiogram interpretation doctor. Incidentally, in the schedule, the day of the week to which a number is set indicates a day on which a radiogram interpretation is charged (the hatched days in the view), and the numerals show the priority order in which the access to a medical image is permitted. For example, although radiogram interpretation doctors who can take charge of the medical image radiographed by the modality “MRI” on Tuesday are “Tanaka” and “Suzuki”, the schedule shows that the radiogram interpretation doctor “Tanaka” who is set to be “1”, the highest priority order, is determined as the radiogram interpretation doctor first. Incidentally, the priority order can also be attached to all of the radiogram interpretation doctors like 1, 2, . . . , or it is also possible to set the priority order “1” to all of the radiogram interpretation doctors to make them to have an equal priority order. Moreover, although the example of the schedule for every day of the week has been described, the schedule is no limited to the example, and may be set to every hour.

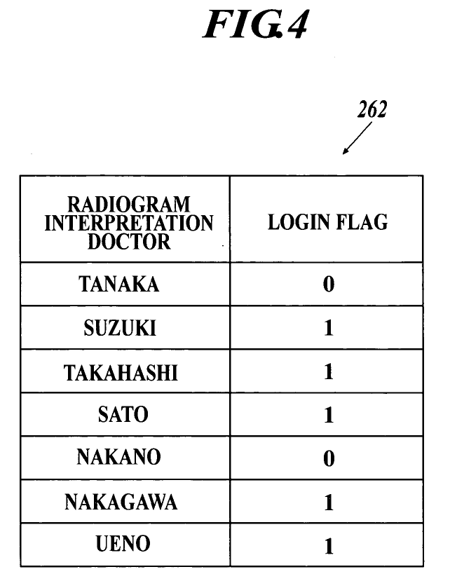

The login table 262 is a table for managing the login situation of each radiogram interpretation doctor in the radiogram interpretation terminals 40. As shown in FIG. 4, a login flag (for example, “1” in case of logging in, and “0” in case of not logging in) indicating whether each radiogram interpretation doctor has logged in or not is set in the login table 262.

The information DB 27 is built on a large-capacity memory. Patient information, examination information, series information, and image related information which are made to be databases of a patient information table, an examination information table, a series information table, and an image related information table, respectively, are severally correlated with the information DB 27. Moreover, a report table for storing report information pertaining to diagnoses is also contained in the information DB 27. Various kinds of information such as a date and a time at which the report was produced, a report file name, a radiogram interpretation doctor name, and a patient name, are made to be a database in the report table.

Moreover, the information DB 27 includes an image management information table produced by making a DICOM compression image generated based on the original image and the information pertaining to the generation of the thumbnail images for an index to be a database. The image management information table includes, for example, the generation date and time of an image, a compression ratio, and the like.

The image DB 30 is a DB of medical images built on a network attached storage (NAS), which is an image storage device, and stores the original image generated by a modality 10, a DICOM compression image and a thumbnail image which have been generated by the server 20 based on the original image to folders according to each image kind. Moreover, the report information containing the data of a report document produced to the medical image is stored in the folder for report saving.

The radiogram interpretation terminals 40 are computer terminals for users such as a radiogram interpretation doctor or an approval doctor (a doctor who approves a radiogram interpretation result) to perform a radiogram interpretation of a medical image, to produce a report of a radiogram interpretation result, or to refer to a report.

The radiogram interpretation terminals 40 are severally equipped with a display unit such as an LCD, and severally display a login screen at the time of an operation start. The radiogram interpretation terminals 40 severally transmit the user information inputted in the login screen to the server 20. Then, when user authentication is performed in the server 20, a medical image list of radiogram interpretation objects transmitted from the server 20 is displayed on the display unit. The list is a list of the medical images which are assigned to a radiogram interpretation doctor who has been authenticated as a user by the server 20 as a radiogram interpretation doctor in charge, and the access to which is permitted to the radiogram interpretation doctor among the medical images stored in the image DB 30. At the time of radiogram interpretation, a radiogram interpretation terminal 40 severally access the medical image specified by the radiogram interpretation doctor in the medical image list, and the radiogram interpretation terminal 40 reads the accessed medical imager from the image DB 30 to display the medical imager on the display unit.

Moreover, the radiogram interpretation terminals 40 severally display past report information and the like acquired from the server 20. Moreover, the radiogram interpretation terminals 40 severally display a report production screen, and produce report information based on the input information on the screen to transmit the produced report information to the server 20.

The film output apparatuses 50 outputs a medical image on a film based on the image data of the medical image.

Next, the operations of the medical image management system 100 at the time of radiogram interpretation are described.

First, a radiogram interpretation doctor inputs user information into any of the radiogram interpretation terminals 40, and logs in to it. At the radiogram interpretation terminal 40, the inputted user information is transmitted to the server 20. The image control processing executed in the server 20 to which the user information has been transmitted is hereinafter described with reference to FIG. 5 is described.

In the image control processing shown in FIG. 5, it is discriminated whether login has been performed to any radiogram interpretation terminal 40 or not based on whether user information has been received from any radiogram interpretation terminal 40 (Step S1). When the user information has been received from any radiogram interpretation terminal 40 and the login has been performed (Step S1; Y), the user information and the user information previously registered into the server 20 are collated with each other, and user authentication is performed. When both the user information is consistent with each other and the radiogram interpretation doctor is authenticated as a normal user, the login flag of the authenticated radiogram interpretation doctor is set to be on, namely “1”, in the login table 262 (Step S2). Then, an application necessary for the radiogram interpretation is transmitted to the radiogram interpretation terminal 40, and the processing shifts to the process at Step S3.

On the other hand, when no user information is received from any radiogram interpretation terminal 40 and no login is performed to any radiogram interpretation terminals 40 (Step S1; N), the processing shifts to the process of Step S3 without performing the process of Step S2. Incidentally, it is supposed that, when login is executed in any radiogram interpretation terminals 40, the processes of the login setting of a radiogram interpretation doctor by these steps S1 and S2 are executed as an interrupt even if another process is performed.

At Step S3, it is discriminated whether a medical image radiographed and generated in a modality 10 has been inputted or not. When no medical images have been inputted from any modalities 10 (Step S3; N), the processing returns to the process of Step S1. When a medical image has been inputted from a modality 10 (Step S3; Y), the inputted medical image is made to be a DB, and the image kind of the medical image is discriminated based on the incidental information of the medical image (Step S4). As the image kind, the kinds such as an X ray image, an MRI image, and CT image are discriminated by referring to the information of the modality which has performed the radiographing.

When the kind of the image has been discriminated, a radiogram interpretation doctor who corresponds to the kind of the image and comes under a day in charge of a radiogram interpretation on the schedule is discriminated based on the schedule table 261 (Step S5). For example, when the day when the medical image was inputted is Tuesday and it is discriminated that the medical image was generated by the modality of “MRI”, it is discriminated that the radiogram interpretation doctors coming under the modality “MRI” is two doctors of “Tanaka” and “Suzuki” in the example of the table shown in FIG. 3.

Subsequently, it is discriminated whether the radiogram interpretation doctor whose priority order is set at the uppermost priority order among the radiogram interpretation doctors according to the kind of the image has already logged in to the radiogram interpretation terminal 40 or not (Step S6). When the description is given based on the example mentioned above, in the schedule table 261, the priority order of the radiogram interpretation doctors “Tanaka” and “Suzuki” on Tuesday is set in the order of “Tanaka” (priority 1) and “Suzuki” (priority 2). Consequently, in the login table 262, it is discriminated whether the login flag of the radiogram interpretation doctor “Tanaka” is set as “1” or not.

When it is discriminated that the login flag of the uppermost priority order radiogram interpretation doctor is set as “1” in the login table 262 and the login of the doctor has been performed (Step S6; Y), the logged-in radiogram interpretation doctor is determined as the newly inputted radiogram interpretation doctor in charge of the medical image, and the access from the radiogram interpretation terminal 40 to which the radiogram interpretation doctor in charger has logged in to the medical image is permitted (Step S7). To put it concretely, a flag indicating the radiogram interpretation doctor in charge to whom access has been permitted is set to the medical image in the image DB 30, and the access from the radiogram interpretation doctors other than the radiogram interpretation doctor in charge indicated by the flag is forbidden. Simultaneously, the list information of the medical image the access to which has been permitted is transmitted to the radiogram interpretation terminal 40 side to which the radiogram interpretation doctor in charge to whom access has been permitted. In the radiogram interpretation terminal 40, the medical image to which the access has been permitted is added to the list of the medical images of radiogram interpretation objects. Thus, when the radiogram interpretation doctor in charge of the medical image has been assigned, the present processing ends.

On the other hand, when the login flag of the radiogram interpretation doctor the priority order of whom is the uppermost priority order is set as “0” in the login table 262 and the doctor has not logged in yet (Step S6; N), it is discriminated whether the radiogram interpretation doctor the priority order of whom is the next highest priority order has been already logged in or not based on the login table 262 (Step S8). For example, when the radiogram interpretation doctor “Tanaka” whose priority order is the uppermost priority order has not logged in, it is discriminated whether the radiogram interpretation doctor “Suzuki” of the priority order 2 has been logged in or not.

When the login flag of the radiogram interpretation doctor of the next highest priority order is “1” and the doctor has already logged in (Step S8; Y), the processing shifts to the process of Step S7. That is, when the medical image of the radiogram interpretation object is assigned to the logged-in radiogram interpretation doctor whose priority order is the next highest priority order and the access to the medical image is permitted, the present processing ends. On the other hand, when the radiogram interpretation doctor whose priority order is the next highest has not logged in also (Step S8; N), it is discriminated whether all radiogram interpretation doctors coming under the kind of the image have not logged in or not based on the login table 262 (Step S9).

When the login flag of any radiogram interpretation doctor is set as “1” among the radiogram interpretation doctors according to the image kind in the login table 262 (Step S9; N), the processing returns to Step S8, and it is discriminated whether a radiogram interpretation doctor has logged in or not in order of the height of the priority. On the other hand, when no radiogram interpretation doctors according to the image kind have logged in in the login table 262 (Step S9; Y), the assignment of the radiogram interpretation doctor in charge of a medical image is once suspended (Step S10), and the present processing ends. It may be performed to the medical image the assignment to which is suspended to repeat the present processing at every predetermined period until the radiogram interpretation doctor according to the image kind logs in, and the medical image may be assigned to the radiogram interpretation doctor whose priority order is the uppermost priority order even when the radiogram interpretation doctor has not logged in.

As mentioned above, according to the present embodiment, a radiogram interpretation doctor who comes under a day in charge of a radiogram interpretation and has logged in is discriminated based on the schedule table 261 and the login table 262, and the radiogram interpretation doctor is determined as the radiogram interpretation doctor in charge of the medical image. Consequently, the medical image of the radiogram interpretation object can be assigned to a radiogram interpretation doctor capable of taking charge of the radiogram interpretation in real time. Herewith, a medical image can be prevented from being assigned to an absentee, and the delay of a radiogram interpretation can be avoided.

Moreover, because the kind of an image is discriminated based on the information incidental to the medical image and a radiogram interpretation doctor according to the kind of the image is determined as the radiogram interpretation doctor in charge, the medical image of the kind which each radiogram interpretation doctor can take charge can be appropriately assigned to each radiogram interpretation doctor.

Moreover, when a plurality of radiogram interpretation doctors who can take charge of the medical image of the same kind exists to the medical image of the same kind, a radiogram interpretation doctor having a higher priority order is sequentially determined as the radiogram interpretation doctor in charge. Consequently, even when the radiogram interpretation doctor having the uppermost priority order is absent and has not logged in, it is possible to determine another radiogram interpretation doctor who has logged in as the radiogram interpretation doctor in charge, and then the delay of the radiogram interpretation of a medical image can be prevented. Moreover, by setting the priority orders, the order of taking charge of a radiogram interpretation according to a business situation is controllable.

In particular, in case of a system including a function of automatically logging off when no operations are preformed after the login of a radiogram interpretation doctor once to a radiogram interpretation terminal 40, the access to a medical image is not permitted to a radiogram interpretation doctor who does not log in according to the embodiment mentioned above. Consequently, it is possible to assign the medical image of the radiogram interpretation object to another radiogram interpretation doctor whose schedule is vacant after the automatic logging off even in the case where the former radiogram interpretation doctor is absent by moving to an operation other than the radiogram interpretation such as a meeting after the radiogram interpretation doctor has logged in. Consequently, the more matched assignment of the medical images in real time according to the business situation of the radiogram interpretation doctors is enabled, and the present invention becomes especially effective.

Incidentally, although a radiogram interpretation doctor who can take charge is discriminated using the information of a modality as the information indicating the kind of medical image in the present embodiment, the information indicating the kind of a medical image is not limited only to the modality information. Each medical department may set a schedule and a priority order of the radiogram interpretation doctor in charge in the schedule table 261, and each medical department may discriminate the radiogram interpretation doctor in charge based on the information of a requesting department incidental to the medical image. Alternatively, each examination room (such as individual examination room of a plurality of MRI examination rooms) may similarly discriminate a radiogram interpretation doctor in charge.

Moreover, a system of referring to patient information, series information and the like stored in the information DB 27 to retrieve the radiogram interpretation doctors each having an experience of taking charge of the patient of the medical image radiographed at this time in the past and to assign the medical image to the logged-in radiogram interpretation doctor in charge may be adopted.

All the contents of the disclosure of Japanese Patent Application No. 2004-245369 filed Aug. 25, 2004 are incorporated in the present application.

### Second Embodiment

In the present embodiment, the following example is described. That is, a learning mode and an automatic mode are provided as the radiogram interpretation mode. In the learning mode, an operation pattern indicating the operation procedure is sampled from the operation history at the radiogram interpretation, and the operation procedure is learned. In the automatic mode, the radiogram interpretation screen is switched in pursuance of the standard pattern set as the most frequently used operation pattern as a result of the learning to be automatically displayed.

First, the configuration is described.

Because the system configuration of the medical image management system in a second embodiment is the same configuration as that of the medical image management system 100 in the first embodiment, the same reference characteristics are attached to the same configuration, and the illustration of the configuration is omitted. That is, as shown in FIG. 1, the medical image management system 100 in the second embodiment comprises the modality 10, the server 20, the image DB 30, the radiogram interpretation terminals 40, and the film output apparatuses 50.

Moreover, the medical image management system 100 is connected to the hospital information system (HIS) 200 through the communication network.

The HIS 200 is an information management system managing the information in a hospital. The HIS 200 generates radiographing order information including patient information pertaining to a patient of a radiographing object such as a patient ID, a name and a sex of the patient, examination information pertaining to an examination such as an examination ID of the examination, a radiographing site specified by the examination and a radiographing method, and the like when the HIS 200 has received a request from a doctor, and the HIS 200 manages the generated radiographing order information by attaching identification information of the radiographing order information (hereinafter referred to order ID). The HIS 200 transmits the generated radiographing order information to each modality 10 of the medical image management system 100.

Incidentally, although the example in which the HIS is applied as the originator of the radiographing order information is described in the present embodiment, the HIS can be applied also to the receptionist terminal which performs issue reception of the radiographing order information, a radiology information system (RIS) managing the information in a department of radiology and the like

Hereinafter, each component of the medical image management system 100 is described.

The modalities 10 are ones generating medical image data by digitizing a medical image produced by radiographing a patient. For example, modalities radiographing medical images of various image kinds such as the images of an MRI apparatus and an ultrasonic photographing apparatus as well as the images of a CR apparatus, a CT apparatus, a reading apparatus reading an X-ray image recording on an X-ray film can be applied.

The modalities 10 radiograph a patient in pursuance of radiographing order information generated by the HIS 200 to generate the data of the medical image. Then, the modalities 10 give the patient information and examination information for specifying a medical image to the generated data of the medical image as the incidental information, and give the series information pertaining to the radiographing such as the names of the modalities 10, the operator name and examination site, and image related information such as the generation day and time of the medical image and bit information to the medical image to transmit the information to the server 20.

A server 20 saves the data of the medical image transmitted from the modalities 10 in an image DB 30 as an original image to manage the data. Moreover, the server 20 manages the login situation of each radiogram interpretation doctor in the radiogram interpretation terminals 40, and limits the input and the output of each medical image saved in the image DB 30 according to the radiogram interpretation doctor who has logged in.

The image DB 30 is a DB of medical images built on a network attached storage (NAS), which is an image storage device, and stores the original image generated by a modality 10, and images for a radiogram interpretation such as a compression image and a thumbnail image which have been generated by the server 20 to folders according to each image kind. Moreover, the report information containing the data of a report document produced to the medical image is stored in the folder for report saving.

The radiogram interpretation terminals 40 are image display apparatuses for medical use for users such as a radiogram interpretation doctor or an approval doctor (a doctor who approves a radiogram interpretation result) to perform a radiogram interpretation of a medical image, to produce a report of a radiogram interpretation result, or to refer to a report.

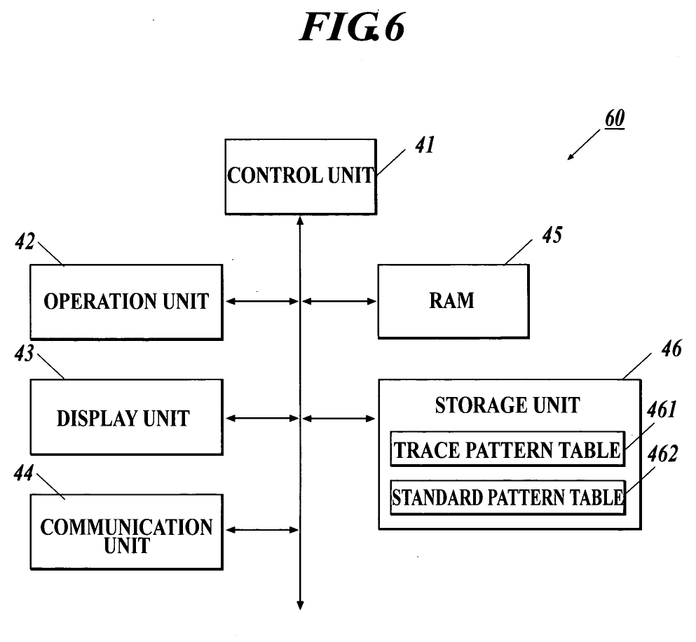

The internal configuration of the radiogram interpretation terminals 40 is shown in FIG. 6.

As shown in FIG. 6, the radiogram interpretation terminals 40 comprise a control unit 41, an operation unit 42, a display unit 43, a communication unit 44, a random access memory (RAM) 45, and a storage unit 46.

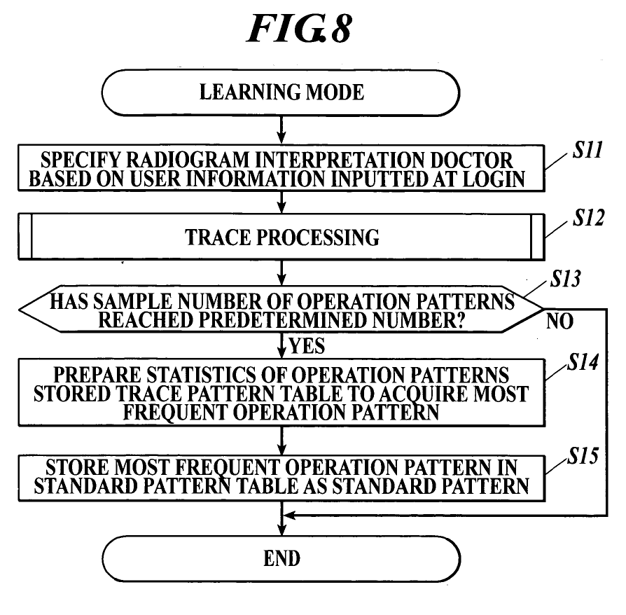

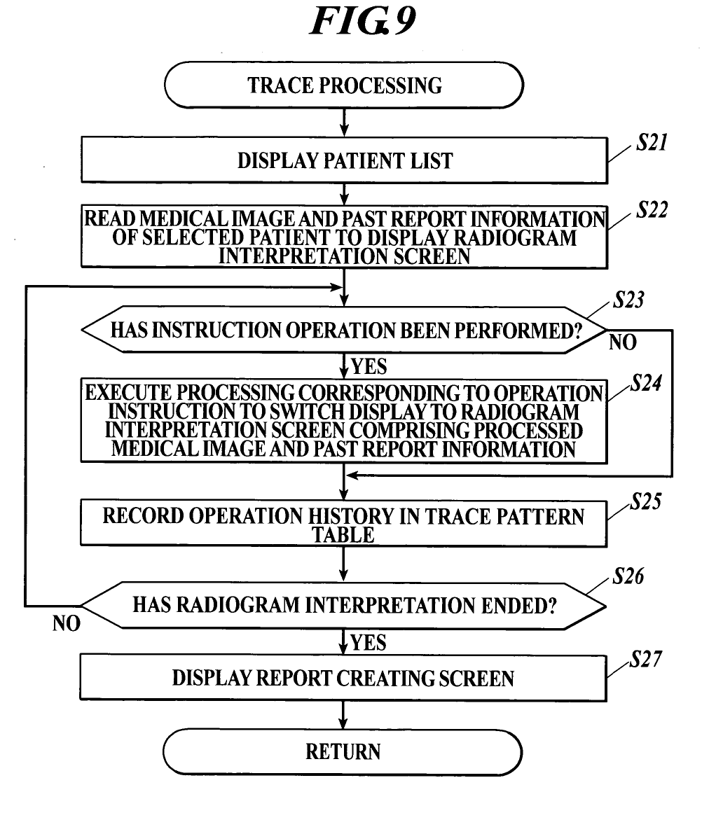

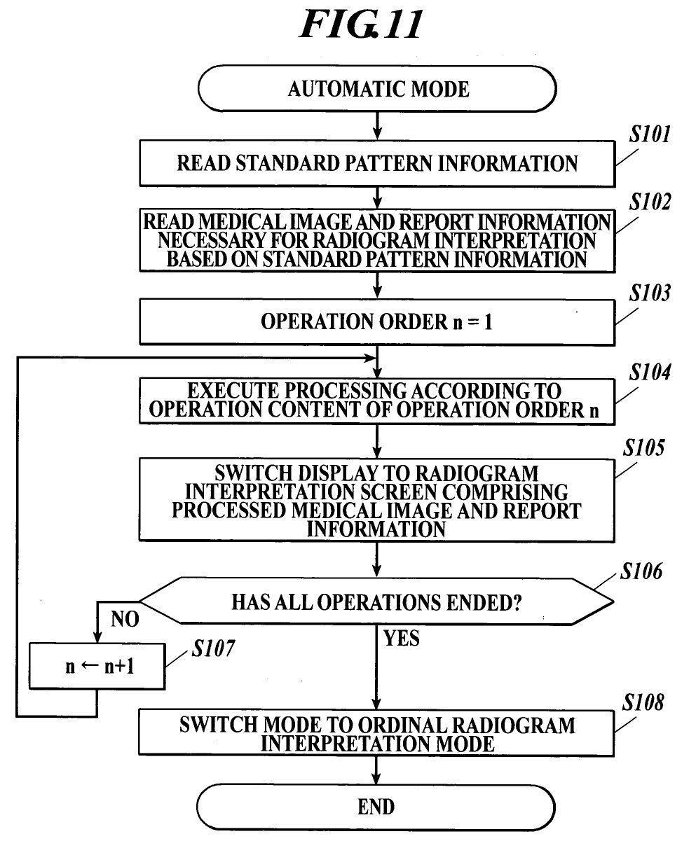

The control unit 41 is a control unit comprising a central processing unit (CPU) and the like. The control unit 21 expands a learning mode processing program (see FIG. 8), a trace processing program (see FIG. 9), an automatic mode processing program (see FIG. 11), and the like according to the present invention as well as the system program stored in the storage unit 46 in the RAM 45, and wholly controls the processing operation by the cooperation with the programs.

In the leaning mode processing, the control unit 41 reads the medical image and the report information of the patient of the radiogram interpretation object from the image DB 30, and generates a radiogram interpretation screen comprising the medical image or the report information to make the display unit 43 display the generated radiogram interpretation screen. When the instruction of the display processing or the image processing of the medical image or the report information is operated through the operation unit 42 in the radiogram interpretation screen, the control unit 41 executes the process in conformity with the instruction operation, and generates a radiogram interpretation screen comprising the medical image or the report information after the processing to make the display unit 43 switch the display to the generated radiogram interpretation screen. At this time, the control unit 41 executes the trace processing, and makes a trace pattern table 461 of the storage unit 46 store a series of operation procedures in each radiogram interpretation screen from the operation history at the radiogram interpretations as the operation pattern information to use as samples of the operation patterns. Then, when the sampler number of the operation patterns by the trace processing reaches a predetermined number, the control unit 41 performs the statistical processing of each operation pattern to acquire the most frequently used operation pattern, and stores the acquired operation pattern in a standard pattern table 462 as the standard pattern.

In the automatic mode processing, the control unit 41 reads standard pattern information from the standard pattern table 462, and the control unit 41 executes an operated instructed process in the order of the operated instructed order in accordance with the same procedure as the operation procedure expressed by the standard pattern in pursuance of the standard pattern information. Then, the control unit 41 generates a radiogram interpretation screen configured by using a processed medical image or processed report information every time of the process, and makes the display unit 43 display the generated radiogram interpretation screen.

The operation unit 42 is an operation unit comprising a keyboard, a mouse, a touch panel integrally configured with the display unit 43, and the like. The operation unit 42 outputs an operation signal corresponding to the operations with the keyboard, the mouse or the touch panel to the control unit 41.

The display unit 43 is a display unit comprising a liquid crystal display (LCD) and the like, and displays various screen data such as a radiogram interpretation screen, a report production screen, and processing results by the control unit 41.

The communication unit 44 comprises an interface for communication such as a network interface card (hereinafter referred to as an NIC) and a modem, and mutually transmits and receives information to and from an external device on the communication network N. For example, the communication unit 44 accesses the image DB 30 to receive the data of a medical image of the radiogram interpretation object, and transmits the report information produced by the radiogram interpretation terminals 41 to the server 20. The RAM 45 forms a work area storing various programs executed by the control unit 41 and the data related to the various programs temporarily.

The storage unit 46 stores a learning mode processing program, a trace processing program, an automatic mode processing program, data processed by each program, and the like as well as a system program.

Moreover, the storage unit 26 is a storage unit for storing a trace pattern table 461 and a standard pattern table 462.

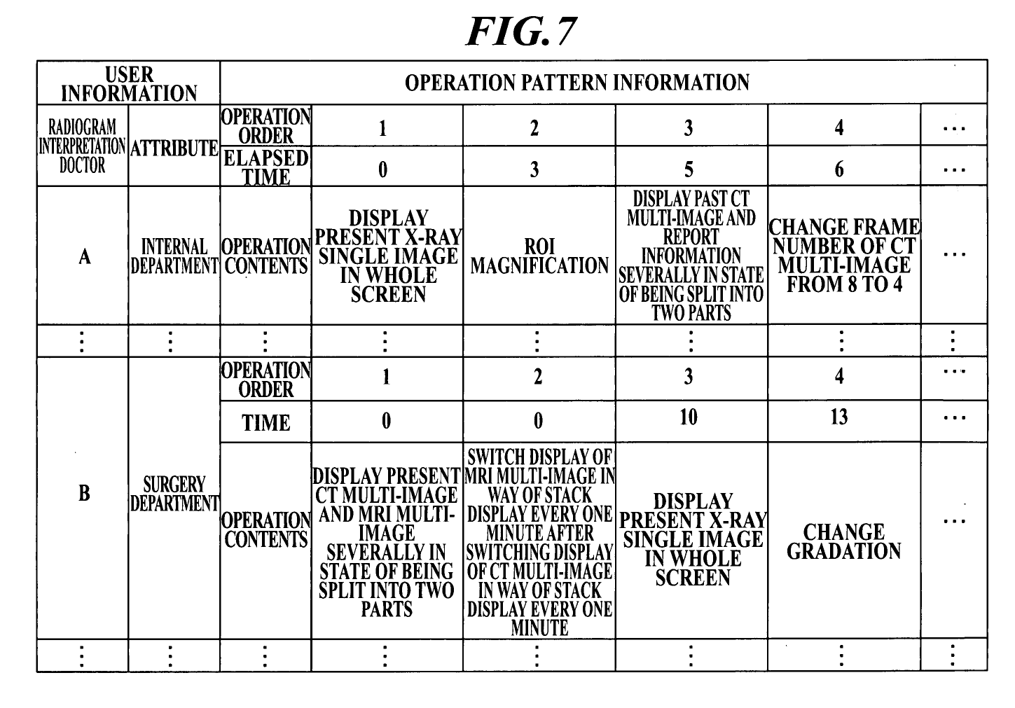

The trace pattern table 461 is a table for storing the operation patterns sampled in trace processing every radiogram interpretation doctor. As shown in FIG. 7, operation pattern information is stored in the trace pattern table 461 in a way of being associated with the user information of radiogram interpretation doctors having executed a series of operations. The names of radiogram interpretation doctors, the information of attributes, and the like are included as the user information. The example of FIG. 7 indicates that a radiogram interpretation doctor “A” belongs to an “internal department.” Moreover, the operation pattern information includes operation orders indicating the orders of the performances of the instruction operations, elapsed times from the commencement of radiogram interpretations to the performances of instruction operations, the information of the operation contents, and the like. In the example of FIG. 7, at the time of the radiogram interpretation of the radiogram interpretation doctor “A”, first an instruction of displaying the present X-ray single image on the whole screen was issued, and after three minutes of the instruction, the instruction operation of display processing of magnifying the region of interest (ROI) was performed.

Incidentally, about the image kinds of medical images, in the following description, “present” indicates a medical image acquired by the examination radiographing at this time, and “past” indicates a medical image acquired by the examination radiographing in the past. Moreover, “X-ray” indicates a medical image radiographed by a CR apparatus. “CT” indicates a medical image radiographed by a CT apparatus. “MRI” indicates a medical image radiographed by an MRI apparatus. Moreover, “single” indicates a display format of displaying only one frame of a medical image in a predetermined display region. “Multi” indicates a display format of displaying a plurality of frames of a medical image in a predetermined display region. For example, a present CT multi-image indicates a medical image acquired by the CT apparatus by the examination radiographing at this time, and the medical image is displayed as a plurality of frames.

On the other hand, the standard pattern table 462 is for storing the operation patterns set as a standard pattern by performing the statistical processing of a plurality of operation patterns stored in the trace pattern table 461 for every radiogram interpretation doctor. Consequently, because the data configuration of the standard pattern table 462 is the same as that of the trace pattern table 461, the illustration and detailed description of the standard pattern table 462 are omitted here. That is, although a plurality of operation patterns are stored to a radiogram interpretation doctor on the trace pattern table 461, only one operation pattern is stored on the standard pattern table 462.

Next, the operation of a radiogram interpretation terminal 40 in the present embodiment is described.

At the time of a radiogram interpretation, on the radiogram interpretation terminal 40, it is possible to select to set one of each radiogram interpretation mode of a normal mode in which screen displays are performed by user's one-by-one operations, a learning mode in which the operation patterns at the radiogram interpretations are sampled and the operations procedure is learned, and an automatic mode in which the radiogram interpretation screens are automatically displayed in pursuance of a standard pattern set based on a learning result. First, the operation of the radiogram interpretation terminal 40 at the time when the automatic mode is set is described after describing the operation of the radiogram interpretation terminal 40 at the time when the learning mode is set.

FIG. 8 is a flowchart illustrating the learning mode processing executed at the time of the learning mode.

In the learning mode processing shown in FIG. 8, first the user information inputted at the time of login to the radiogram interpretation terminal 40 and the user information of each radiogram interpretation doctor previously registered in the radiogram interpretation terminal 40 are collated, and the specification of a radiogram interpretation doctor is performed based on the collation result (Step S11). When a radiogram interpretation doctor is specified, the processing shifts to the trace processing at Step S12.

The trace processing is described with reference to the flowchart shown in FIG. 9.

In the trace processing shown in FIG. 9, first the patient list screen for selecting a patient of the radiogram interpretation object is displayed on the display unit 43 (Step S21). Then, the present medical image, or the medical image radiographed in the past and the past report information, of the patient operated to be selected in the patient list screen is read from the image DB 30, and a radiogram interpretation screen in which the present or the past medical image or the report information is arranged and configured in an initially set display format is generated. Then, the radiogram interpretation screen is displayed on the display unit 43 (Step S22).

On the displayed radiogram interpretation screen, the instruction operations of various kinds of processing execution are possible for a radiogram interpretation doctor through the operation unit 42. For example, it is possible for the radiogram interpretation doctor to operate the instructions of various kinds of display processing such as the alteration of the image kind of the displayed medical image (such as the kind of radiographing method such as a CT image and an MRI image and the kind of the medical image having changed with the elapse of time from the past to the present) and the alteration of the split number of the display regions. Alternatively, the radiogram interpretation doctor can operate the instruction of image processing of the displayed medical image such as a magnification/reduction process, a gradation conversion process, and a sharpness enhancement process.

The radiogram interpretation terminal 40 performs the discrimination whether an instruction operation has been performed or not on the radiogram interpretation screen through the operation unit 42 (Step S23). When an operation of instructing the execution of any processing has been performed by a radiogram interpretation doctor on the radiogram interpretation screen (Step S23; Y), the display processing or the image processing according to the instruction operation is executed to the medical image and the report information displayed on the radiogram interpretation screen. A radiogram interpretation screen comprising the processed medical image and the report information is newly generated. Then, when the display is switched from the radiogram interpretation screen having been displayed on the display unit 43 to the newly generated radiogram interpretation screen (Step S24), an operation history such as the operation order of the performed instruction operation, an elapsed time from the commencement of the radiogram interpretation to the performance of the instruction operation, and the operation contents are store in the trace pattern table 461 in the way of being associated with the user information of the radiogram interpretation doctor who has been specified at Step S11 (Step S25), and the processing shifts to the process of Step S26. On the other hand, when instruction operation has not been performed (Step S23; N), the processes of the Steps S24 and S25 are omitted, and the processing shifts to the process at Step S26.

At Step S26, it is discriminated whether the radiogram interpretation on a radiogram interpretation screen has ended and an instruction operation of producing a report has been issued or not. When the instruction operation of report producing has not been made and the radiogram interpretation is not ended (Step S26; N), the processing returns to the process of Step S23, and the storage of the operation history on the radiogram interpretation screen displayed by being switched is repeated.

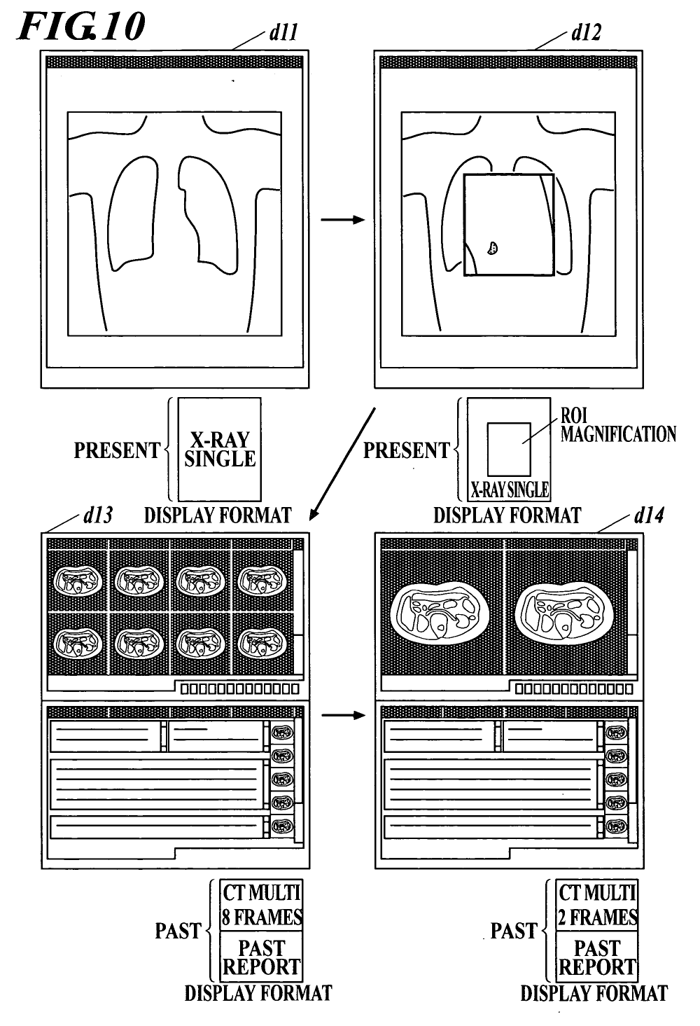

An example of the operation history is shown in FIG. 10.

As shown to FIG. 10, when a radiogram interpretation screen d11 on which a present X-ray single image is arranged on the whole screen is displayed to start a radiogram interpretation and an instruction operation of the magnification display processing of an ROI is performed after three minutes later than the commencement of the radiogram interpretation, the magnification display processing to the X-ray single image is executed in response to the instruction operation, and the display is switched to the display of a radiogram interpretation screen d12. At this time, as shown in the data configuration example in the trace pattern table 461 in FIG. 7, the information of “3” (minutes) is stored in the elapsed time item of the operation order “2”, and the information of the “ROI magnification” is stored. Successively, when the instruction operation of a display processing of performing the two-split display of the past CT multi-image and the past report information is issued, a radiogram interpretation screen d13 produced by the execution of the display processing is switched to be displayed, and the operation history is stored in the item of the operation order “3” in the trace pattern table 461. After that, when the instruction operation of the display processing changing the 8-frame display of the CT multi-image to the 2-frame display is performed in the radiogram interpretation screen d13, the display is switched to a radiogram interpretation screen d14 produced by the execution of the display processing, and the information of the operation history is stored in the trace pattern table 461.

On the other hand, when an instruction operation of report producing is made and the radiogram interpretation is ended (Step S26; Y), a report production screen is displayed on the display unit 43 (Step S27). The radiogram interpretation doctor can produce a report by inputting a diagnostic result and the like on the report production screen.

When the report production screen is displayed on the radiogram interpretation terminal 40, the processing shifts to the process of Step S13 shown in FIG. 8.

At Step S13, it is discriminated whether the sample number of the operation patterns of the radiogram interpretation doctor stored in the trace pattern table 461 has reached a predetermined number or not (Step S13). Incidentally, the predetermined number is supposed to be able to be set appropriately. When the sample number does not reach the predetermined number (Step S13; N), the processes at Steps S14 and S15 is omitted, and the present processing is ended. When the sample number has reached the predetermined numeral (Step S13; Y), the statistical processing of each operation pattern is performed based on the trace pattern table 461, and an operation pattern with the heist frequency of use is acquired (Step S14). When the operation pattern of the highest frequency of use is acquired, the operation pattern is stored in the standard pattern table 462 as the standard pattern (Step S15), and the present processing is ended.

Next, with reference to FIG. 11, the automatic mode processing executed at the time of the automatic mode is described. Incidentally, as a premise of description, it is supposed that a patient list screen has been displayed previously and the patient of the radiogram interpretation object has been selected on the patient list screen.

In the automatic mode processing shown in FIG. 11, first standard pattern information is read from the standard pattern table 462 (Step S101), and a medical image and report information necessary for a radiogram interpretation are discriminated based on the standard pattern information to be read from the image DB 30 (Step S102).

Subsequently, a parameter n indicating an operation order is set as n=1, which is an initial value (Step S103). Then, the processing according to the operation contents of the operation order n set in the standard pattern information is executed to the read medical image or the report information (Step S104), and the radiogram interpretation screen comprising the processed medical images or report information is generated, and the generated radiogram interpretation screen is displayed on the display unit 43 (Step S105).

Subsequently, it is discriminated whether operations have been completed in accordance with all the operation histories set in the standard pattern information or not (Step S106). When not all the operations have been completed (Step S106; N), the operation order n is incremented by one to be set (Step S107), and the processing returns to the process of Step S104. Then, the display of the radiogram interpretation screen according to the instruction operation of the next operation order n+1 is repeated. That is, the switching display of the radiogram interpretation screens is automatically performed as operated in the same procedure as the operation procedure shown by the standard pattern. For example, the operation procedure in the standard pattern For example, in the case where the operation procedure in the standard patter is (operation order 1) the display process of the present X-ray single image, (operation order 2) the ROI magnification process, (operation order 3) a past CT multi (eight-split) image and a past report information 2-split display process, (operation order 4) a display process of changing the display frame number of a past CT multi-image from 8 to 2, it coming out, display processing or image processing according to each instruction operation is executed when it has reached the elapsed time of each order of the operation orders 1-4. Then, as shown in FIG. 10, the radiogram interpretation screens are switched to be displayed in the order of the radiogram interpretation screens d11, d12, d13 and d14.

On the other hand, when all the operations have been completed (Step S106; Y), the mode is changed to the normal mode (Step S108), and the present processing is ended. When the radiogram interpretation doctor has an image including his or her concern among each radiogram interpretation screen automatically displayed in the automatic mode, the radiogram interpretation doctor can again start the radiogram interpretation in the normal mode. In the normal mode, because display operations are preformed one by one, only the image including the concern may be displayed.

As mentioned above, at the time of learning mode, the sampling of the operation patterns is performed from the operation history of each radiogram interpretation screen at the time of a radiogram interpretation, and an operation pattern with the highest frequency of use is set as the standard pattern. In the time of the automatic mode, because the display processing or the image processing is executed to the medical image or the report information in pursuance of the operation procedure by the standard mode and a radiogram interpretation screen comprising the processed medical image or the report information is switched to be displayed, the display of a series of radiogram interpretation screens can be automatized by the same procedure as that of the operation procedure performed in the past. Because a radiogram interpretation doctor is only required to observe the radiogram interpretation screens automatically switched to be displayed and is not required to perform any operations, the load of the radiogram interpretation operation of the radiogram interpretation doctor can be reduced.

Moreover, because the operation pattern with the highest frequency of use by each radiogram interpretation doctor is set as the standard pattern, the standardization of the operation procedures in a series of radiogram interpretation screens can be attained. For example, the operation procedure is customizable so that a radiogram interpretation screen may be automatically displayed by the operation pattern which is the easiest to a radiogram interpretation for every radiogram interpretation doctor.

Incidentally, although the present embodiment describes the example which acquires a standard pattern for every radiogram interpretation doctor, the operations patterns may be sampled by a plurality of groups to which a plurality of radiogram interpretation doctors belongs, for example, by the unit of medical department, by the unit of hospital, and the like, and the stander patter may be acquired for every group. Herewith, the operation patterns can be standardized for every group, and the operation procedures at the time of radiogram interpretations can be unified. Moreover, even if a radiogram interpretation doctor has a shallow experience can perform a radiogram interpretation similarly to the radiogram interpretation procedure of a skilled radiogram interpretation doctor by setting the operation patter of the skilled radiogram interpretation doctor as a standard pattern, and the improvement in overall working efficiency and a diagnostic level can be aimed at.

Moreover, it may be adopted to acquire a standard pattern for every site of a diagnosis object (such as a chest, a head, a breast, and the like), or for every image kind of a medical image (such as an X-ray image, a CT image, an MRI image, and the like). The radiogram interpretation is frequently executed for every cite or image kind made as a special subject to study, and can cope with actual using way suitably by standardizing the operation patterns for every site or every image kind in such a way.

Moreover, although the standard patter is acquired by sampling a plurality of operation patterns and performing the statistical procedure of the sampled oration patterns, the operations patter of a target operation procedure may be only once sampled to be set as the standard pattern as it is without performing the statistical processing. Moreover, a plurality of operation patterns may be sampled to be stored as candidate pattern information, and let a radiogram interpretation doctor select an operation pattern to use among the candidate patterns at the next radiogram interpretation. Herewith, an operation pattern to be used can be changed according to a diagnosis object, the inclination on that day, and the like, and more flexible customization can be performed.

Furthermore, a list indicating the operation procedure in the standard pattern may be possible to be displayed, and the operation procedures may be made to be added, deleted or changed in the list. Herewith, the customization according to the inclination of the radiogram interpretation doctor and a radiogram interpretation situation can be performed.

All the contents disclosed in Japanese Patent Application No. 2004-245394 filed on Aug. 25, 2004 are incorporated in the present application.

What is claimed is:

1. A medical image management system comprising:
an image storage device storing a medical image acquired by radiographing;
a radiogram interpretation terminal reading and displaying the medical image from the image storage device according to an instruction inputted by a radiogram interpretation doctor;
a schedule storage unit for storing schedule information setting a date and time when each radiogram interpretation doctor takes charge of a radiogram interpretation;
a login storage unit for storing login information to every radiogram interpretation doctor, the login information indicating whether the radiogram interpretation doctor has logged in to the radiogram interpretation terminal or not; and
a control unit, when a medical image of a radiogram interpretation object is stored in the image storage device, for discriminating a radiogram interpretation doctor who is set as a radiogram interpretation doctor in charge at a specified date and time and having logged in to the radiogram interpretation terminal based on the schedule information and the login information and for determining the radiogram interpretation doctor as a radiogram interpretation doctor in charge of the medical image stored in the image storage device.

2. The medical image management system of claim 1, wherein the schedule storage unit stores information of a kind of a medical image the radiogram interpretation of which each radiogram interpretation doctor takes charge of as well as the schedule information of each radiogram interpretation doctor, and
the control unit discriminates the kind of the medical image based on information pertaining to an image incidental to the medical image of the radiogram interpretation object to determine a radiogram interpretation doctor as the radiogram interpretation doctor in charge of the medical image based on the stored schedule information and the information of the kind of the medical image the radiogram interpretation of which each radiogram interpretation doctor takes charge of, the determined radiogram interpretation doctor set as a doctor in charge of the radiogram interpretation at a specified date and time based on the schedule information and having logged in to the radiogram interpretation terminal among radiogram interpretation doctor(s) corresponding to the discriminated kind.

3. The medical image management system of claim 2, wherein, when a plurality of radiogram interpretation doctors are set to a medical image of the same kind, the schedule storage unit stores a priority order of radiogram interpretations set to the plurality of radiogram interpretation doctors, and
the control unit discriminates the radiogram interpretation doctors having logged in to the radiogram interpretation terminal in order of the height of the stored priority order to determine the discriminated radiogram interpretation doctor as the radiogram interpretation doctor in charge.
